(19) United States
(12) Patent Application Publication
(10) Pub. No.: US 2017/0297287 A1
(43) Pub. Date: Oct. 19, 2017

(54) PRODUCTION METHOD OF GLUELESS PASTED INTEGRALLY MODELING SHOE SOLE

(71) Applicant: EEFOAM MATERIALS CO., LTD., TAICHUNG CITY (TW)

(72) Inventor: CHUN-HSIUNG WU, TAICHUNG CITY (TW)

(21) Appl. No.: 15/133,147

(22) Filed: Apr. 19, 2016

(51) Int. Cl. B29D 35/12; A43B 13/12; A43B 13/04

(52) U.S. Cl. CPC B29D 35/122; A43B 13/04; A43B 13/122

(57) ABSTRACT

A production method of glueless pasted integrally modeling sole comprising the following steps: taking a rubber outsole compound in a mold to perform partial vulcanization; taking a midsole compound in the mold to simultaneously perform pressurizing and heating together with the rubber outsole compound that has been partially vulcanized to simultaneously generate more vulcanization of the rubber outsole compound and foaming reaction of the midsole compound and occurring adhesion; and completing glueless adhering and pasting for the rubber outsole and the foaming midsole after the mold is cooled down so as to obtain a sole finished product. Accordingly, it can greatly reduce the procedure of forming soles, decrease labor force at great quantity and energy use, and reduce the proportion of producing waste and also achieves the efficacies of reducing costs and energy saving and carbon reduction at the same time.

### BACKGROUND OF THE INVENTION

### 1. Field of the Invention

The invention relates to a production method of sole, and more particularly to a production method of integrally modeling sole to paste rubber outsoles and foaming midsoles without using glue or hot melt adhesive.

### 2. Description of the Related Art

A conventional sole production method comprises the following steps: (1) preparing rubber outsole: firstly completing vulcanization of rubber outsole compound, then performing treatments of surface grinding, rinsing, drying, primer brushing and gluing for the portion to be pasted on the rubber outsoles that are completed with vulcanization so as to produce rubber outsoles; (2) performing the foaming, cutting, surface grinding, rinsing, drying, primer brushing and gluing for foamed midsoles to produce the foamed midsoles; and (3) finally, performing pasting and pressurizing for the rubber outsoles, which is produced and treated, and the foamed midsoles so as to complete sole finished products.

However, the foregoing conventional production process for respectively producing and mutually pasting rubber outsoles and foamed midsoles is too complicated to use labor forces at a great quantity. It does not only take tedious long production time but also produces material loss during production process.

In addition, China patent CN1243061A disclosed a production method of sport shoe sole that is a production method of pasting EVA shoe midsole and unvulcanized rubber outsole compound and comprising steps: (1) production and processing of EVA shoe midsole: treatments containing foaming and cutting, slicing, cutting and edge-grinding according to required thickness and form; (2) rubber part material production: compounding and cutting into required size; (3) integrally modeling EVA midsole and unvulcanized rubber: gluing the pasting portion to place the rubber outsole and the EVA midsole into the mold so as to produce finished products after heating and cooling. The patent does not only require the forming, processing and use of glue for shoe midsoles but also has limited processing procedures to be reduced.

### SUMMARY OF THE INVENTION

Therefore, upon the foregoing problem of easily producing disposal to increase costs due to complicated procedure of producing and forming shoe soles and requiring labor forces at great quantity and energy use, it is an objective of the invention to provide a production method of glueless pasted integrally modeling sole comprising the following steps: taking a rubber outsole compound in a mold to perform partial vulcanization; taking a midsole compound in the mold to simultaneously perform pressurizing and heating together with the rubber outsole compound that has been partially vulcanized to simultaneously generate more vulcanization of the rubber outsole compound and foaming reaction of the midsole compound and occurring adhesion; and completing glueless adhering and pasting for the rubber outsole and the foaming midsole after the mold is cooled down so as to obtain a sole finished product. Accordingly, it can greatly reduce the procedure of forming soles, decrease labor force at great quantity and energy use, and reduce the proportion of producing waste and also achieves the efficacies of reducing costs and energy saving and carbon reduction at the same time.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of production flow path according to a preferred embodiment;

### DETAILED DESCRIPTION OF THE PREFERRED EMBODIMENTS

The technical content of the present invention will become apparent by the detailed description of the following embodiments and the illustration of related drawings as follows.

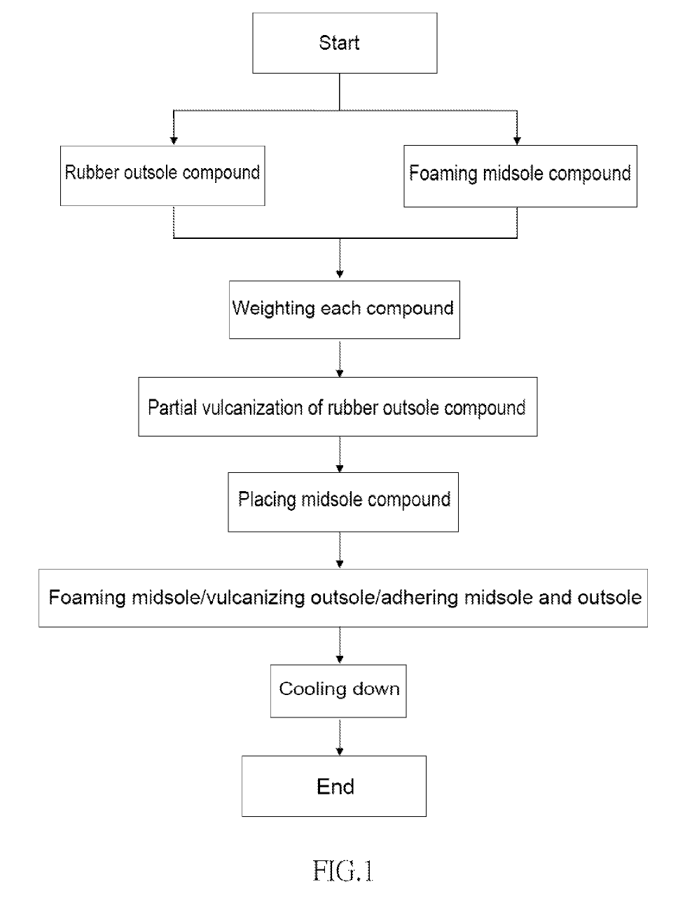

With reference to FIG. 1, a production method of glueless pasted integrally modeling sole according to a preferred embodiment of the invention is provided and mainly comprises the following steps:

With reference to FIG. 1, (A) partial vulcanization of rubber outsole compound: preparing a rubber outsole compound, and it is placed into a mold preheated at 150 degree Celsius to 160 degree Celsius after cutting it into a proper shape and weighting. Further, a middle frame is placed, and the mold is covered to pressurize for a suitable set time, wherein the time is 10%-90% normal completed vulcanization as the procedure of partially vulcanizing the rubber outsole compound.

With reference to FIG. 1, (B) a midsole compound (such as pellets or sheets) capable of foaming in-mold is prepared and is reserved after weighting.

With reference to FIG. 1, (C) the mold is opened after pressurizing to achieve the set time in step (A), and the middle frame is taken out. At the same time, the midsole compound is rapidly placed to close the mold and pressurize at 150 degree Celsius to 170 degree Celsius for a suitable set time so that the rubber outsole compound and the midsole compound are pressurized and heated to respectively generate more vulcanization and foaming reaction and generate adhesion.

With reference to FIG. 1, when the mold, which reaches the pressurized and heated set time, is cooled below 70 degree Celsius, the mold can be opened to take the sole finished product out. The sole finished product comprises the rubber outsole and the foaming midsole that have been completely vulcanized.

Accordingly, since there is no need to use glue between the rubber outsole and the foaming midsole in the process of producing the sole finished product, the adhesive strength can reach above 2.5 KG/CM.

With the production method disclosed by the invention, it can greatly reduce the procedure of forming soles, decrease labor force at great quantity and energy use, and reduce the proportion of producing waste and also achieves the efficacies of reducing costs and energy saving and carbon reduction at the same time.

Secondarily, the rubber outsole compound can be formed by mixing conventional nature rubber (NR), butadiene rubber (BR), styrene-butadiene rubber (SBR) at different proportions according physical property.

In addition, the rubber outsole compound used by the invention can be added with waste tire powder to reduce material costs except nature rubber (NR), butadiene rubber (BR), styrene-butadiene rubber (SBR), thereby having the efficacy of reproducing and using waste disposal.

The in-mold foaming midsole compound (pellets or sheets) used in the invention is thermoplastic elastomer of polyolefin elastomer, styrenic elastomer, and thermoplastic polyurethane elastomer to incorporate with a foaming agent mixture. The foaming agent mixture is 4,4 P,P-oxybis benzene sulfonyl hydrazide and micro-capsule blowing agent further added with other ingredients of crosslinking agents and crosslinking auxiliary agents.

While the means of specific embodiments according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A production method of glueless pasted integrally modeling sole, mainly comprising:
taking a rubber outsole compound in a mold to perform partial vulcanization;
taking a midsole compound in the mold to simultaneously perform pressurizing and heating together with the rubber outsole compound that has been partially vulcanized to simultaneously generate more vulcanization of the rubber outsole compound and foaming reaction of the midsole compound and occurring adhesion;
completing glueless adhering and pasting for the rubber outsole and the foaming midsole after the mold is cooled down so as to obtain a sole finished product.

2. The production method of glueless pasted integrally modeling sole of claim 1, wherein the compound of the rubber outsole is formed by mixing nature rubber (NR), butadiene rubber (BR), styrene-butadiene rubber (SBR) at different proportions according physical property.

3. The production method of glueless pasted integrally modeling sole of claim 2, wherein the compound of the rubber outsole further has above 5% scrap tire powder.

4. The production method of glueless pasted integrally modeling sole of claim 1, wherein temperatures of performing partial vulcanization for the rubber outsole compound in the mold are 150 degree Celsius to 160 degree Celsius.

5. The production method of glueless pasted integrally modeling sole of claim 1, wherein temperatures of performing pressurizing for the midsole compound in the mold are 150 degree Celsius to 170 degree Celsius.

6. The production method of glueless pasted integrally modeling sole of claim 1, wherein the compound of the midsole is any one from pellets and sheets.

7. The production method of glueless pasted integrally modeling sole of claim 1, wherein the compound of the midsole is any one from thermoplastic elastomer of polyolefin elastomer, styrenic elastomer, and thermoplastic polyurethane elastomer.

8. The production method of glueless pasted integrally modeling sole of claim 7, wherein the compound of the midsole contains a foaming agent mixture, and the foaming agent mixture is 4,4 P,P-oxybis benzene sulfonyl hydrazide and micro-capsule blowing agent.

9. The production method of glueless pasted integrally modeling sole of claim 1, wherein a temperature of cooling down the mold is below 70 degree Celsius.
